(19) United States
(12) Patent Application Publication
(10) Pub. No.: US 2010/0277397 A1
(43) Pub. Date: Nov. 4, 2010

(54) Detection of surface and buried objects

(75) Inventor: Waymond Scott, Lilburn, GA (US)

Correspondence Address: FISH & RICHARDSON P.C., P.O. BOX 1022, MINNEAPOLIS, MN, 55440-1022, US

(73) Assignee: L-3 Communications CyTerra Corporation, Waltham, MA (US)

(21) Appl. No.: 12/659,309

(22) Filed: Mar. 3, 2010

Related U.S. Application Data
(60) Provisional application No. 61/157,098, filed on Mar. 3, 2009.
(60) Provisional application No. 61/243,814, filed on Sep. 18, 2009.

(51) Int. Cl. H01Q 1/00

(52) U.S. Cl. 343/904

(57) ABSTRACT

An antenna includes a resistive element formed in a casing, and a feed line formed in the casing and electrically coupled to the resistive element. The positioning of the resistive element and the feeding is such that the feed line is approximately perpendicular to the resistive element. The positioning of the feed line and the resistive element may result in the antenna being sized to allow integration of the antenna into a sensor head.

### CROSS-REFERENCE TO RELATED APPLICATIONS

This application claims priority to U.S. Provisional Application Ser. No. 61/157,098, titled DETECTION OF SURFACE AND BURIED OBJECTS, and filed on Mar. 3, 2009 and to U.S. Provisional Application Ser. No. 61/243,814, titled CONTINUOUS WAVE METAL DETECTOR, and filed on Sep. 18, 2009. Both of these applications are incorporated by reference in their entirety.

### TECHNICAL FIELD

This disclosure relates to detection of surface and buried objects.

### BACKGROUND

A large percentage of land mines contain some amount of metal. Many types of mines use metal for firing pins, shrapnel, and portions of the casing. If a mine has a sufficient quantity of a detectable metal, that mine can be found using a metal detector.

### SUMMARY

Techniques for detecting surface and buried objects, such as land mines, unexploded ordnances, pipes, reserves of liquid, and power lines are disclosed. In particular, a movable and controllable arm is attached to a platform such that a sensor head coupled to the arm may move independently of the platform. The sensor head includes sensors that are used to image the surface of the ground and/or a region beneath the surface of the ground. The sensor head may be used to image through or into other turbid, dense, or compacted media.

The platform may be, for example, an autonomous robotic vehicle or a platform that is movable from place-to-place but is stationary while the sensor head is collecting data. Thus, in the techniques discussed below, the motion of the sensor head is not dependent upon the motion of the platform. As compared to techniques in which the motion of the detection sensors corresponds to the motion of the platform, moving the sensor head independently of the platform may allow for an increased scan speed, improved detection rates and/or lower false alarm rates, and the ability to cover larger swaths of ground than a system in which the sensor head and platform move together.

As discussed below, the platform is stationary while the sensor head scans over a region. Keeping the platform stationary may improve the quality of the data collected by the sensor head because the collected data is not contaminated by noise and artifacts that may result from the motion of the platform. For example, if the platform moves while the data is collected, jitter resulting from the motion of the platform may appear as noise in the collected data. The jitter may be worse in situations in which the platform travels over rough terrain. Additionally, by moving the sensor head independently of the platform, the sensor head may be readily repositioned to re-scan a particular area. In contrast, in systems in which the sensor head moves with the platform, the entire platform is repositioned in order to rescan a particular area. Repositioning the entire platform may take longer than repositioning the sensor head. Additionally, the techniques discussed below may free up space on the platform for other items, such as, for example, a neutralization device and/or a marking device.

The sensor head may be an integrated sensor head that includes a continuous-wave metal detector (CWMD) and a ground-penetrating radar (GPR), both of which are located in the sensor head.

In one general aspect, a sensor head includes a ground penetrating radar (GPR) system and a continuous-wave metal detector (CWMD). The GPR system includes a transceiver configured to transmit radiation toward an object and to receive radiation from the object. The CWMD includes a transmission antenna configured to produce a first magnetic field in the vicinity of the object sufficient to generate a current in the object, and a receive antenna configured to sense a second magnetic field produced by the current generated in the object.

Implementations may include one or more of the following features. The outer surface of the sensor head is formed by rigid material that forms part of the GPR. The sensor head also may include a housing that holds the GPR and CWMD. The GPR system may include at least two transceivers and the receive antenna of the CWMD is positioned between the two transceivers. The GPR transceiver may include an antenna configured to transmit the radiation and an antenna configured to receive the radiation. The sensor head also may include a shell, the GPR transceiver may be mounted in an opening formed in the shell, and the receive antenna of the CWMD may be placed about the opening such that the receive antenna and the GPR transceiver are interleaved. The receive antenna of the CWMD may be wrapped around the opening and another opening in the shell such that the receive antenna forms a figure-eight shape. The GPR system includes multiple antennae configured to transmit and receive radiation. The GPR system and the CWMD may be co-located in the sensor head.

In another general aspect, a system includes a sensor head including a continuous-wave metal detector (CWMD) and a ground-penetrating radar (GPR). An articulating arm is coupled to the sensor head. The articulating arm configured to move the sensor head independently of a platform on which the articulating arm is mounted.

Implementations may include one or more of the following features. The system may include an electronic processor and an electronic storage. The electronic storage may include instructions, that when executed, cause the processor to receive data from the sensor head, and control the articulating arm to position the sensor head. The data may be received from the GPR and CWMD in parallel. The electronic processor and the electronic storage may be mounted on the articulating arm. The platform may be a movable platform. The articulating arm may include a non-metallic material. The system also may include a rotation plate coupled to the articulating arm and the sensor head. The rotation plate may be coupled to the articulating arm at a pivot point to allow the sensor head to rotate in all directions about the pivot point.

In another general aspect, a method of scanning a region for subsurface objects includes positioning a platform in the vicinity of a region having a surface and a subsurface, controlling an articulating arm coupled to the platform and holding a sensor head to position the sensor head at a first position above a first portion of the region, and controlling the articulating arm to move the sensor head through a swath to a second position above a second portion of the region. The motion of the sensor head is independent of a position of the platform.

Implementations may include one or more of the following features. The platform may be moved to a position in the vicinity of a second region having a surface. The platform may stationary while the articulating arm moves the sensor head from the first position to the second position. The sensor head may be activated while the sensor head moves from the first position to the second position. Data representative of the subsurface of the swath may be received from the sensor head. The data received from the sensor head may be analyzed, a region of interest may be identified in the data, a position of the region of interest may be determined, and the sensor head may be moved to the position of the region of interest while the platform is stationary. After moving the sensor head to the position of the region of interest, the sensor head may dwell over the region of interest to collect first data representative of the region of interest and second data representative of the region of interest. Receiving data from the sensor head may include receiving data from a GPR and CWMD that are included in the sensor head.

In another general aspect, an antenna includes a resistive element formed in a casing, and a feed line formed in the casing and electrically coupled to the resistive element. The positioning of the resistive element and the feeding is such that the feed line is approximately perpendicular to the resistive element.

Implementations may include one or more of the following features. The resistive element may be a resistive vee. The positioning of the feed line and the resistive element may result in the antenna being sized to allow integration of the antenna into a sensor head. A radar-absorbing material may surround the feed line.

In another general aspect, a method of operating an integrated sensor head includes receiving data collected by a continuous-wave metal detector (CWMD). The data includes a representation of a magnetic field produced by a current flowing in a metallic object that has a known position relative to the CWMD. The received data is analyzed to identify the representation of the magnetic field produced by the metallic object, and the received data is compensated to minimize the identified representation.

Implementations may include one or more of the following features. The metallic object may include one or more of a metallic portion of a ground penetrating radar (GPR) included in the sensor head with the CWMD and a metallic arm coupled to the sensor head. Compensating the received data may include removing the representation. A pre-determined constant level may be removed from the received data.

Other implementations are within the scope of the claims. Implementations may include a method or process, a system or apparatus, an antenna, a sensor head, or computer software stored on a computer-accessible medium.

### DESCRIPTION OF THE DRAWINGS

FIG. 1 shows an illustration of an example system for detecting surface and buried objects.

FIGS. 2A-2D show overhead views of an example system for detecting surface and buried objects.

FIG. 3 shows a perspective view of an example system for detecting surface and buried objects.

FIG. 4 shows an example of a mount for a sensor head.

FIGS. 5A-5C show a top view of a sensor head.

FIG. 6 shows a perspective view of a mounting arm.

FIG. 7 shows an example process for scanning a region with a sensor head.

FIGS. 8A-8E illustrate the sensor head scanning the region.

FIG. 9A shows a cross-section of a sensor head.

FIG. 9B shows a perspective view of the exterior of the sensor head.

FIG. 10 shows an example process for analyzing data from a continuous-wave metal detector (CWMD).

FIG. 11 shows an example process for operating a sensor head.

FIG. 12 shows a block diagram of a sensor head.

FIGS. 13A and 13B show cross-sections of an antenna.

FIG. 14 shows a perspective view of a sensor head.

FIGS. 15A-15C are schematic diagrams of an interior of the sensor head.

FIG. 16 shows an illustration of a CWMD receive coil.

Like reference numbers refer to like elements.

### DETAILED DESCRIPTION

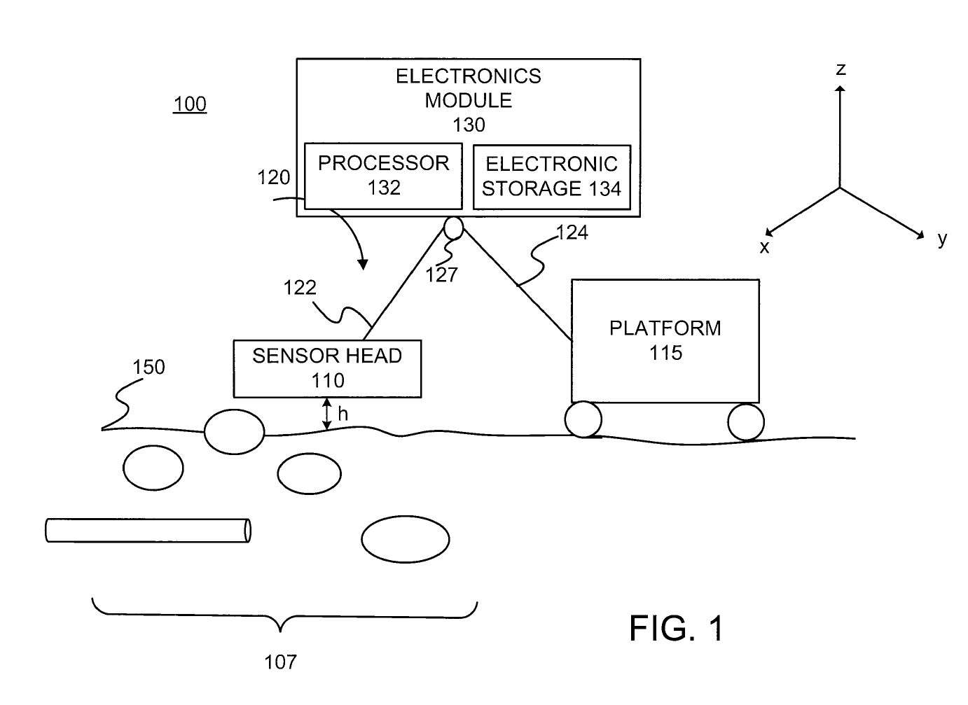

Referring to FIG. 1, a system 100 for detecting surface and buried objects 107 is shown. The system 100 includes a sensor head 110 that is attached to a platform 115 through an electronically controllable and movable arm 120. The arm 120 allows the sensor head 110 to move independently of the platform 115. The system 100 also includes an electronics module 130 that includes a processor 132 and an electronic storage 134. The electronic storage stores instructions for formatting, analyzing, and/or processing data received from the sensor head 110 and for performing autonomous object detection on the data received from the sensor head 110.

In the example shown in FIG. 1, the arm 120 includes a forearm 122 and a front arm 124. However, in other examples, the arm 120 may be a unitary arm coupled directly between the sensor head 110 and the platform 115. The sensor head 110 may move in the x, y, and/or z direction relative to the forearm 122. The forearm 122 is coupled to the front arm 124 by a pivot point 127. The pivot point 127 allows the forearm 122 to move independently of the front arm 124 and the platform 115.

The sensor head 110 may include more than one sensor configured to detect surface and buried objects. Thus, the sensors included in the sensor head 110 may be considered to be integrated together in the sensor head 110. The height “h” of the sensor head 110 above ground 150 determines the height above ground 150 of each of the sensors included in the sensor head 110. Accordingly, integration of the multiple sensors in the sensor head 110 may eliminate the need to determine and/or control the height of the individual sensors, which may lead to a simplified design and improved performance.

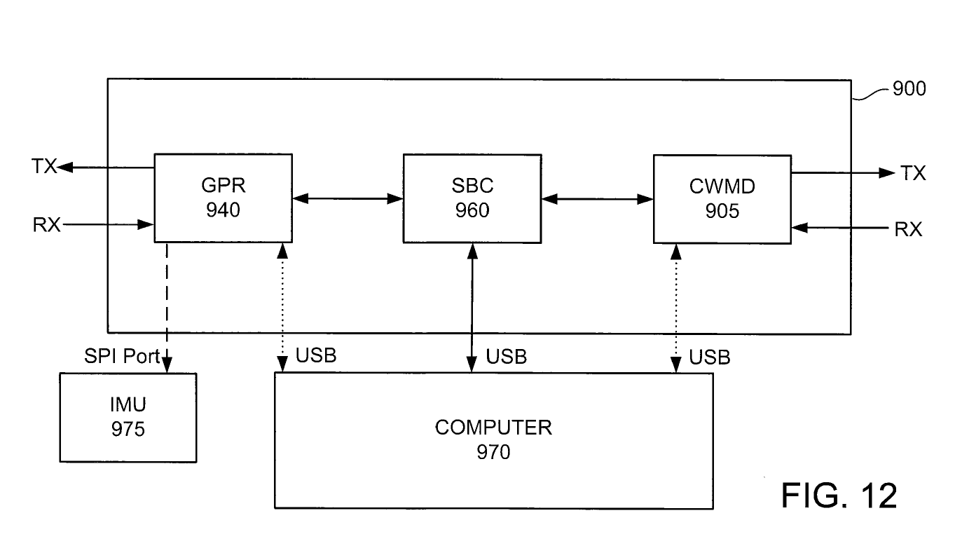

The sensor head 110 may include, for example, a ground penetrating radar sensor, such as a GPR transceiver 940 shown in FIGS. 9A and 12, and a metal detector, such as a continuous wave metal detector (CWMD) 905 shown in FIGS. 9A and 12. The ground penetrating radar may be a stepped-frequency continuous wave radar. In some implementations, the sensors may be modified and reduced in size such that the sensors may be integrated with other sensors in the sensor head. For example, the ground penetrating radar may have a folded over feed to reduce the size of the radar. The metal detector may be made smaller by making the metal detector from adjacent antennas that do not overlap and accounting for the metal detector antennas being adjacent rather than overlapping through signal and data processing techniques.

The electronics module 130 includes a processor 132 and an electronic storage 134 that stores instructions for processing data received from the sensor head 110 and for performing autonomous object detection on the data received from the sensor head 110. The electronics module 130 may format the data received from the sensor head 110 into images that are automatically analyzed for the presence of surface or buried objects. The analysis may include anomaly detection that identifies regions of interest within the images. The regions of interest correspond to physical locations that may include surface or buried objects. The analysis also may include additional processing of the regions of interest with, for example, parallel sets of neural network classifiers. The additional processing may be performed on data collected in an initial scan made by the sensor head 110 and/or the additional processing may be performed on data collected in an additional scan. The additional scan may be made by moving the sensor head 110 with the arm 120 (independently of the platform 115) to a physical region associated with the region of interest identified by the anomaly detector.

In the example shown, the platform 115 is wheeled. However, in other examples, the platform 115 may be a tracked robotic vehicle. The forearm 122 may be made from a plastic or other lightweight material.

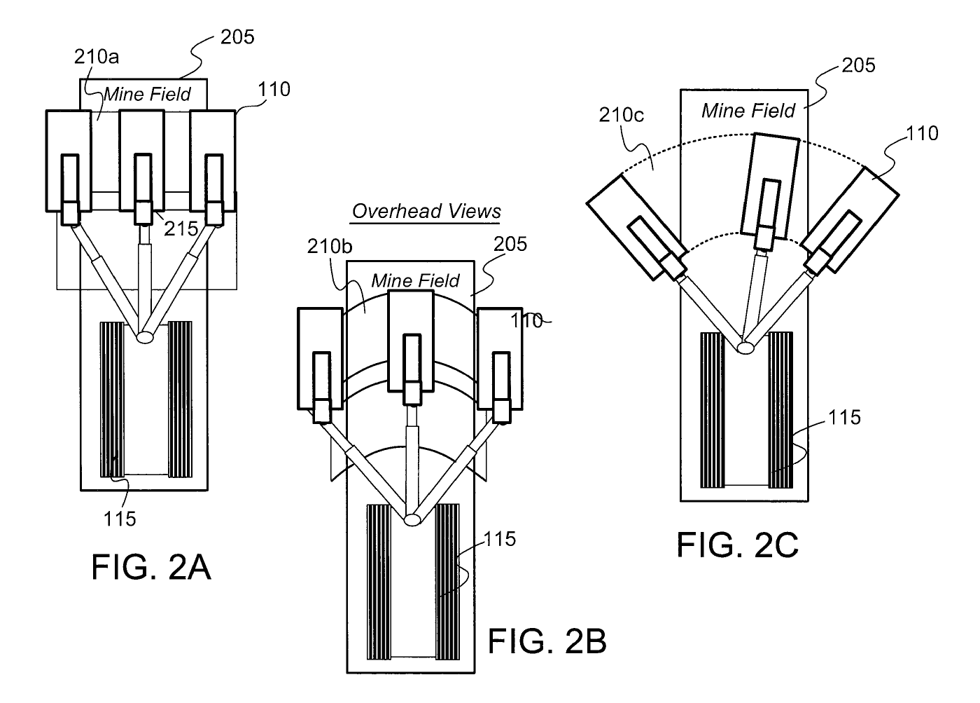

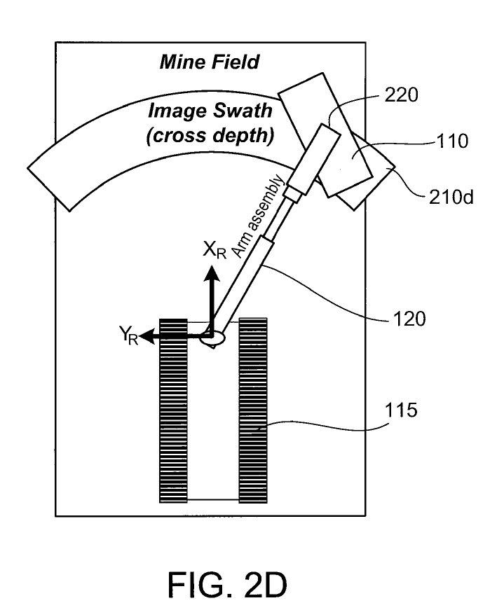

Referring to FIGS. 2A-2D, overhead views of four implementations of the system 100 are shown. FIGS. 2A-2C show overhead views as the system 100 scans a minefield 205. In the examples shown in FIGS. 2A-2C, the platform 115 is stationary while the sensor head 110 moves relative to the platform 115 to scan a swath defined by the motion of the sensor head 110. In FIGS. 2A-2C, the motion of the sensor head 110 defines swaths 210a, 210b, and 210c, respectively. Data may be collected by the sensor head 110 as the sensor head 110 scans the swath. The sensor head 110 may be considered to scan when the sensor head is moving and/or collecting data. The positioning of the sensor head 110 with respect to the arm 120 determines the shape of the swath. The swath 210a that is shown in FIG. 2A is rectilinear. A rectilinear swath may be achieved by keeping a bottom edge portion 215 of the sensor head 110 parallel with the platform 115. The swath 210b shown in FIG. 2B is an arc formed by keeping the sensor head 110 oriented in one position as the arm 120 moves. The swath 210c is also an arc and may be referred to as a “wiper scan” and is formed by moving the arm 120 relative to the platform 115 and holding the sensor head 110 still with respect to the arm 120.

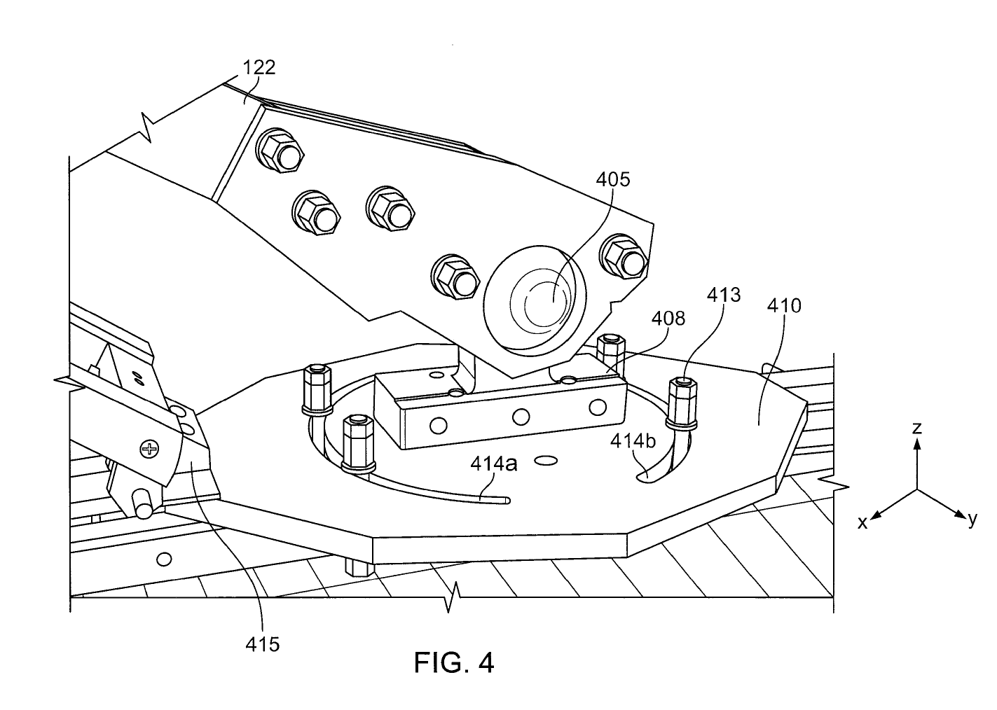

Referring to FIG. 2D, the sensor head 110 is mounted on the arm 120 with a wrist 220. The wrist 220 is discussed in more detail below with respect to the pivot mounting 400 shown in and discussed with respect to FIG. 4. The wrist 220 allows the sensor head 110 to move about the end of the arm 120, e.g., by pivoting about arm 120. Pivoting the sensor head 110 gives greater flexibility in scanning a region.

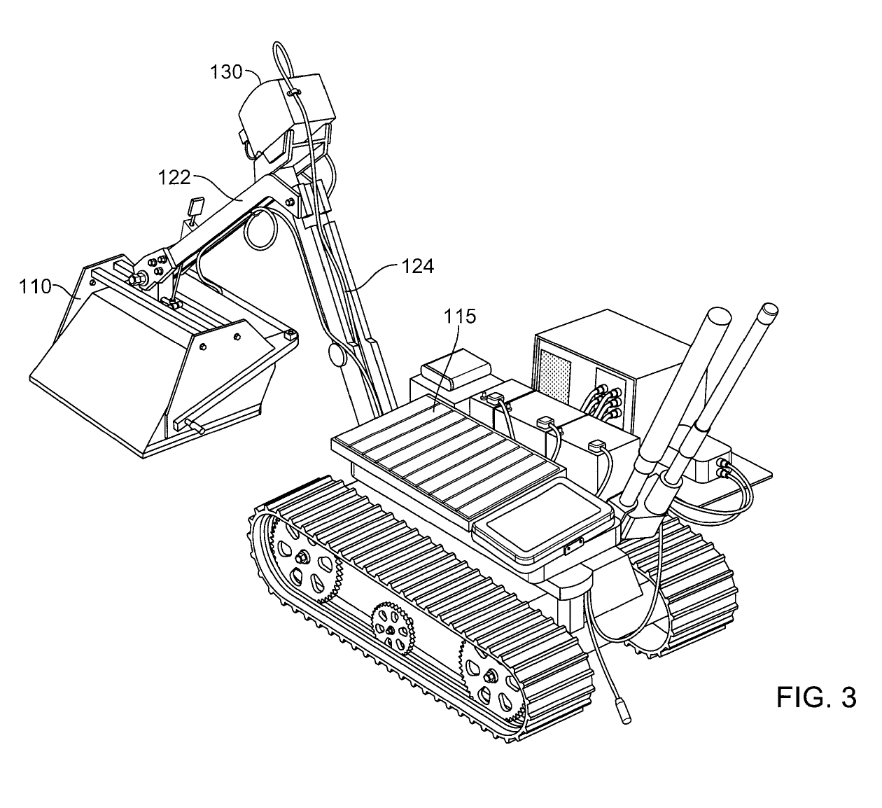

Referring to FIG. 3, a perspective view of an example implementation of the system 100 is shown. FIG. 3 shows an example of the front arm 124, the forearm 122, the electronics module 130, and the sensor head 110. In the example shown in FIG. 3, the sensor head 110 includes an integrated ground penetrating radar and continuous wave metal detector, such as GPR 940 and CWMD 905 illustrated in FIG. 9A, and the platform 115 is a tracked robotic vehicle.

By allowing the sensor head 110 to move independently of the platform 115, the techniques discussed above and in the following description may help address challenges presented by “plow” or “push broom” systems in which the sensors (such as ground penetrating radars and metal detectors) are fixed on the platform (e.g., a vehicle) such that the sensors move with the platform. For example, the sensors of “plow” and “push broom” systems typically collect data over a swath having a size that is determined by the size of the sensor. For example, a “plow” system may include a radar that is one-half-meter wide, and, thus, the “plow system” collects data over a one-half-meter wide swath as the vehicle moves through the swath. In contrast, as a result of being mounted on the arm 120, the sensor head 110 may be swept over a wider area as compared to the width of the platform and the sensor head. Additionally, the data collected by the “plow” system may be contaminated by noise that occurs as a result of the vehicle moving as the system collects data.

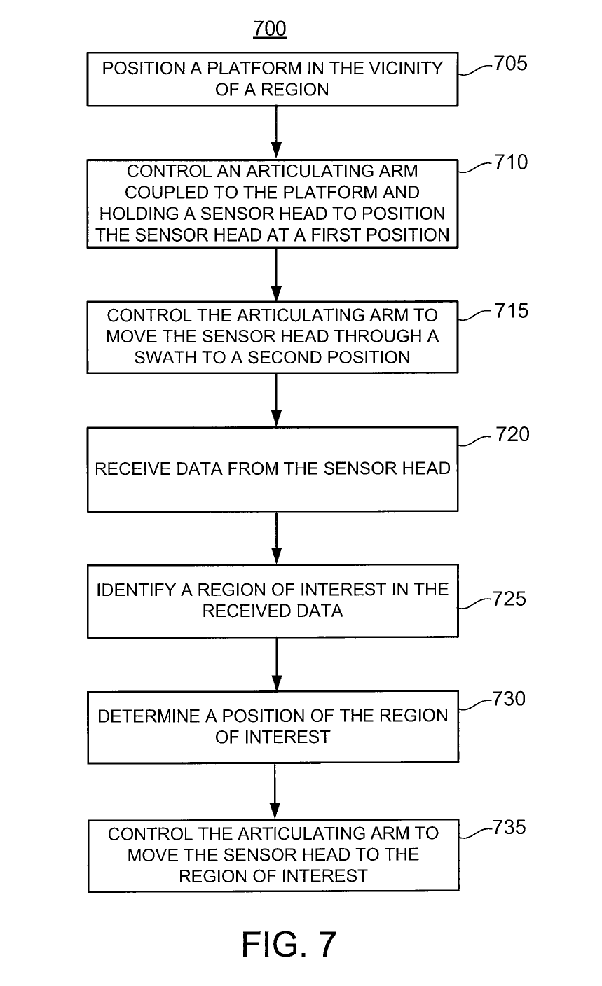

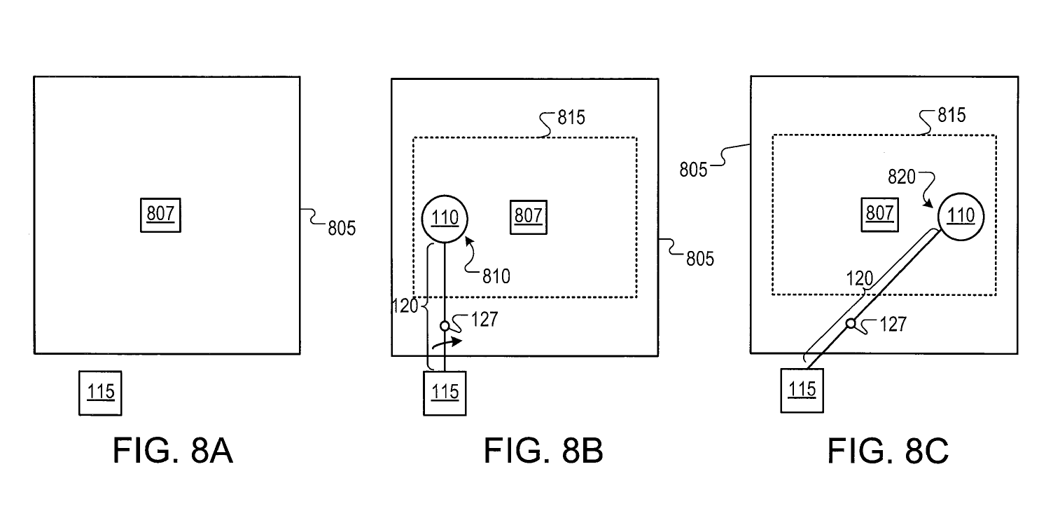

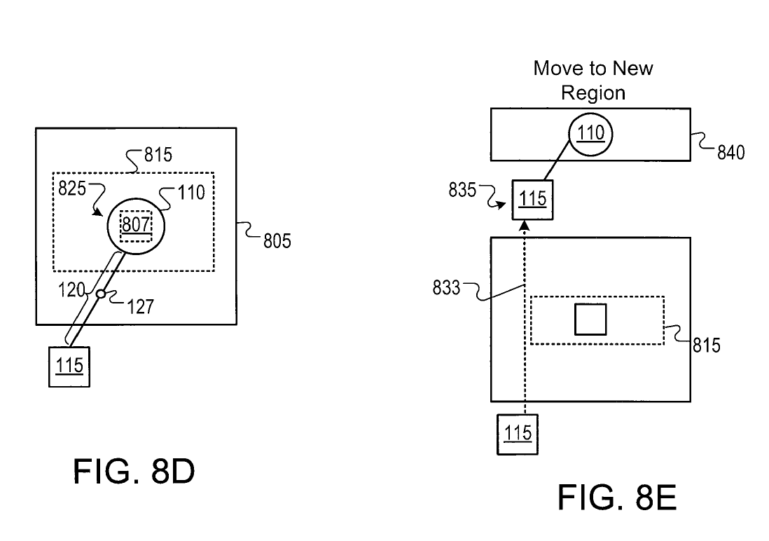

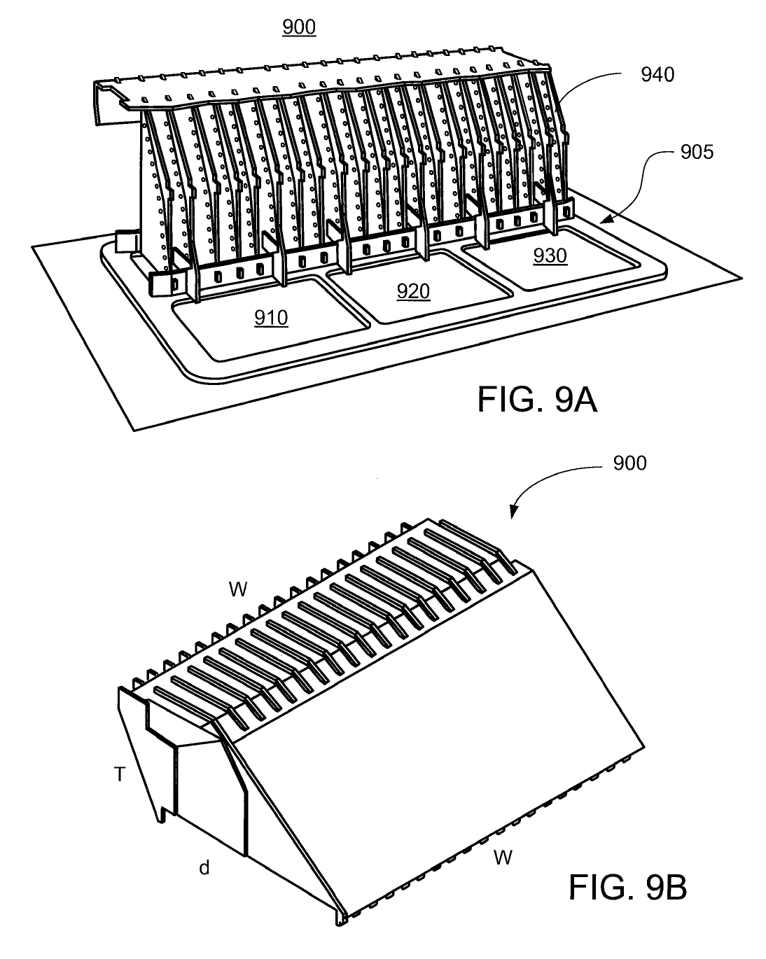

Accordingly, mounting the sensor head 110 on the arm 120 allows the sensor head 110 to move independently of the platform 115 and may result in improved performance as compared to systems in which the motion of the sensor head is determined by the motion of the platform on which the sensor head is mounted. FIGS. 4-6 and their accompanying text illustrate and discuss various implementations of mounting of the sensor head 110 on the arm 120, and FIGS. 7 and 8 show an example process for scanning a region using the sensor head 110.

Referring to FIG. 4, an example of a pivot mounting 400 that allows the sensor head 110 to articulate in any direction relative to the arm 120, and specifically, to the forearm 122 of arm 120, is shown. As discussed in greater detail below, the sensor head 110 is sufficiently light weight to be supported by the arm 120. Coupling the sensor head 110 to the arm 120 allows for the sensor head 110 to be moved independently of a platform (not shown) to which the arm 120 is attached. In addition to moving the sensor head 110 independently of motion of the platform, the pivot mounting 400 enables the sensor head 110 to move in all, or almost all, directions about the forearm 122.

As shown in FIG. 4, the pivot mounting 400 may be coupled to the arm 120 at an end of the forearm 122 and away from the pivot point 127. The pivot mounting 400 includes a pivot ball 405 that is coupled to a rotation plate 410. The pivot ball 405 allows the sensor head 110 to tilt and rotate about the pivot ball 405, and relative to the arm 120, in all, or almost all, directions to allow for virtually unlimited sensor head articulation. The rotation plate 410 is also coupled to a pitch hinge 415. The pitch hinge 415 controls the pitch of the rotation plate 410 relative to the forearm 122. Thus, the combination of the pivot ball 405 and the pitch hinge 415 provides for multiple degrees of rotation, pitch, and angularity between the rotation plate 410, the arm 120, the platform 115, and relative to the minefield 205. In this manner, the sensor head 110 is provide with virtually unlimited articulation.

The rotation plate 410 couples to the sensor head 110 through bearings 413 mounted to the rotation plate 410 through tracks 414a and 414b. The bearings 413 allow the sensor head 110 to rotate about the forearm 122 in the x-y plane. The bearings 413 are held in the tracks 414a and 414b, which, in the example of FIG. 4, are openings formed in the rotation plate 410. Although in the example shown each of the tracks 414a and 414b form continuous openings in the rotation plate 410, in other examples, the tracks may be lipped ruts or pockets that hold the bearings 413 but do not pass through the rotation plate 410.

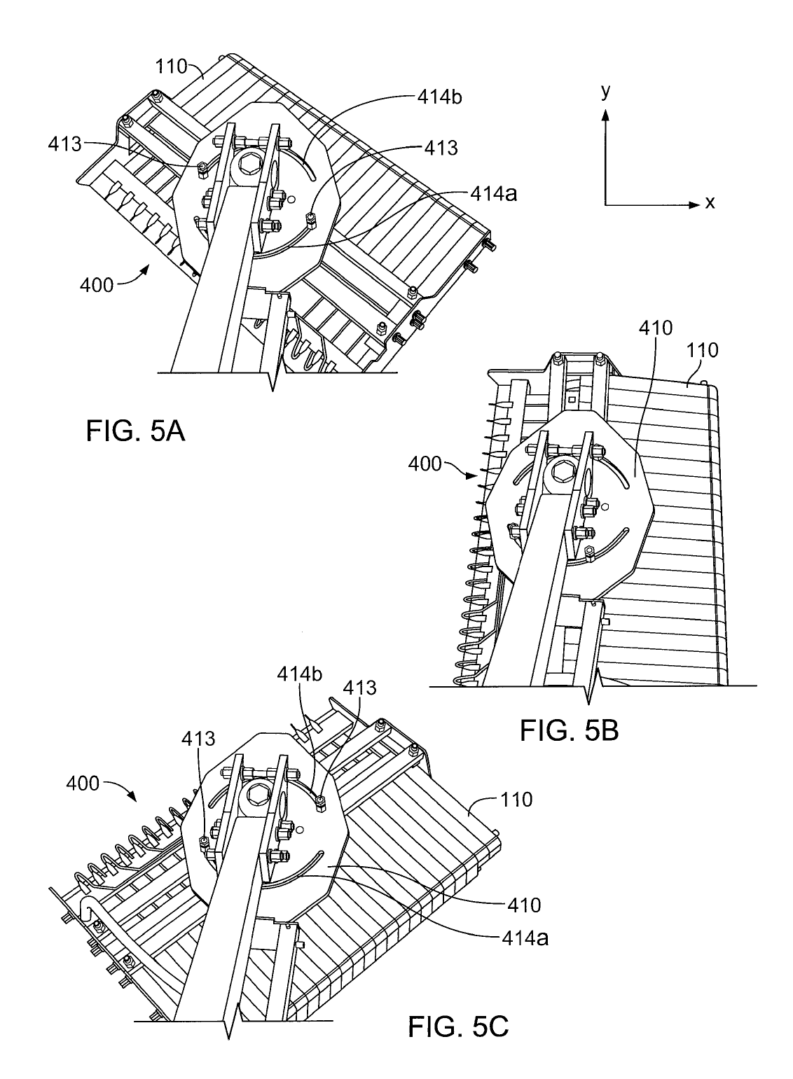

FIGS. 5A-5C show a top view of the sensor head 110 in three different positions. In this example, the pivot mounting 400 rotates the sensor head 110 through three positions for a total rotation of about ninety degrees in the x-y plane. FIG. 5A shows the sensor head 110 in an initial position with the bearings 413 at either end of the tracks 414a and 414b. Referring to FIG. 5B, the sensor head 110 is shown rotated approximately 45-degrees in the x-y plane from the initial position shown in FIG. 5A. The bearings 413 are near the center of the tracks 414a and 414b. Referring to FIG. 5C, the sensor head 110 is shown rotate about 45-degrees from the position shown in FIG. 5B. As compared to their positions in FIG. 5A, the bearings 413 are now at the other end of the tracks 414a and 414b. In the example shown in FIGS. 5A-5C, the tracks 414a and 414b in the rotation plate 410 allow the sensor head 110 to rotate about 90-degrees in the x-y plane. Other implementations of the rotation plate 410 may allow for different amounts of rotation of the sensor head 110.

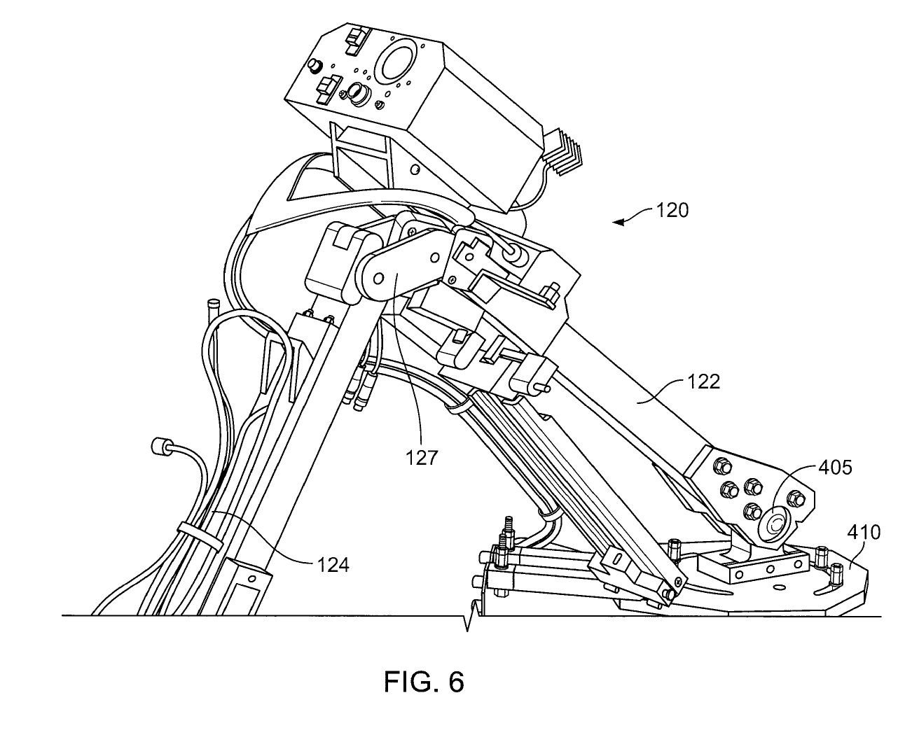

Referring to FIG. 6, a perspective view of the mounting arm 120 is shown. The mounting arm 120 includes the pivot point 127, the forearm 122, and the front arm 124. The forearm 122 couples to the rotation plate 410. As discussed above, the pivot mounting 400, the mounting plate 410, and/or the arm 120 allow the sensor head 110 to move independently of a platform to which the arm 120 and the sensor head 110 are attached.

FIG. 7 shows an example process for scanning a region with a sensor head. FIGS. 8A-8E illustrate the sensor head scanning the region. FIGS. 8A-8D illustrate an example of scanning a region with the sensor head 110, and FIG. 8E illustrates moving the platform 115 to a second region.

The process 700 may be performed by one or more processors in an electronics interface, such as processor 132 of the electronics module 130 discussed with respect to FIG. 1. The processor(s) may be included in the sensor head 110 or the processor(s) may be separate from the sensor head 110, by, for example, being placed on the arm 120 or on the platform 115. Regardless of the relative placement of the sensor 110 and the processor(s), the processor(s) and the sensor head 110 are in communication such that the processor(s) receives data from the sensor head 110 and/or the sensor head 110 receives data from the processor.

Referring to FIG. 7, the platform 115 is positioned in the vicinity of a region (705). The platform 115 is positioned in the vicinity of the region by positioning the platform 115 close enough to the region so that the arm 120 may be controlled to place the sensor head 110 over a portion of the region. The region may be a portion of ground where land mines are buried, underground utility instruments (such as pipes or wires) are located, or minerals and fluids (such as oil or water) are thought to be located. The arm 120, which is coupled to the platform 115 and holds the sensor head 110, is articulated to position the sensor head 110 at a first position (710).

Referring also to FIG. 8A, the platform 115 is positioned in the vicinity of a region 805. The region 805 includes an region of interest 807 that is not apparent upon ordinary observation of the region 805. For example, the region of interest 807 may be a region that includes a buried land mine or a subsurface reserve of oil. Referring to FIG. 8B, the articulation of the arm 120 positions the sensor head 110 at a first position 810 that is vertically above a first portion of the region 805. The sensor head 110 is positioned at the first position 810 without moving or repositioning the platform 115 from its initial location shown in FIG. 8A.

Referring also to FIG. 7 and FIG. 8C, the articulating arm 120 is controlled to move the sensor head 110 through a swath to a second position 820 (715). The arm 120 may control the sensor head 110 such that the sensor head 110 sweeps out a ninety-degree arc swath at about ten degrees per second. The rate of the sweep may be monitored by an inertial measurement unit (IMU). As shown in FIG. 8C, the second position 820 is within the region 805. Additionally, the second position 820 is within the swath 815. The motion of the sensor head 110 may define the swath 815. For example, the swath 815 may be a region over which the sensor head 110 passes as it moves from an initial position within the region 805 to a final position within the region 805.

As shown in FIG. 8C, the platform 115 does not move or change positions as the sensor head 110 moves from the first position 810 to the second position 820. Thus, the motion of the sensor head 110 from the first position to the second position is independent of the position of the platform 115. Accordingly, the motion of the sensor head 110 does not depend on the motion of the platform 115 and the data collected by the sensor head 110 does not include the noise that may arise from the motion of the platform 115.

Referring to FIGS. 7 and 8D, data is received from the sensor head 110 (720). In some implementations, the sensor head 110 is activated and produces data while the sensor head 110 moves from the first position 810 to the second position 820. Thus, the data received from the sensor head 110 is a representation of the surface and/or subsurface portions of the region 805 between positions 810 and 820. The region of interest 807 is identified in the received data (725), and a position 825 of the region of interest 807 is determined (730). As shown in FIG. 8D, the articulating arm 120 moves the sensor head 110 from the second position 820 to the position 825 to position the sensor head 110 over the region of interest 807 (735). The platform 115 may remain stationary while the arm 120 positions the sensor head 110 over the region of interest 807. The sensor head 110 may remain over the region of interest 807 collecting for a period of time that is longer than the amount of time that the sensor head 110 collected data over other parts of the swath 815, resulting in the collection of additional data over the region of interest 807. The additional data may result in a higher resolution representation of the swath 815. Collecting the additional data only over the region of interest 807, as opposed to the entire swath 815, allows concentration on fewer areas that are more likely to include objects of interest. Finally, because the sensor head 110 moves independently of the platform 115, unlike some prior systems, there is no need to move the platform 115 to rescan the portion of the region 805 that includes the region of interest 807. Such a technique may allow for the entire region 805 to be searched more quickly while also allowing for rescanning of regions of interest to yield more accurate results.

Referring to FIG. 8E, the platform 115 may move from its initial position shown in FIGS. 8A-8D along a path 833 to a location 835 in the vicinity of a second region 840. Prior to moving to the location 835, the articulating arm 120 may be controlled to draw the sensor head 110 closer to the platform 115 and hold the sensor head 110 in a fixed position in preparation for moving the platform 115 to the location 835. The sensor head 110 also may be deactivated such that the sensor head 110 does not collect data as the platform moves from the initial position shown in FIGS. 8A-8D to the location 835. However, in some implementations, the sensor head 110 remains activated as the platform travels along the path 833 to the location 835 shown in FIG. 8E. In these implementations, the motion of the sensor head 110 may be correlated to the motion of the platform 115 to the extent that the articulating arm 120 is fixed in place as the platform 115 moves to the location 835.

Thus, the sensor head 110 may be scanned or moved independently of the platform 115.

As discussed above, in some implementations, the sensor head 110 includes multiple sensors. In general, a sensor produces a measure of a phenomenology detected by the sensor.

For example, ground penetrating radar (GPR) measures dielectric contrast, metal detectors produce an indication of an amount of metal in an object of interest, and an X-ray detector produces an indication of a material's ability to absorb X-ray radiation. Thus, using multiple different types of sensors to detect how a particular object interacts with different types of radiation may provide more information about an object than a single sensor. For example, a metal detector and a GPR together may detect metallic objects, non-metallic objects, and objects that include both metallic and non-metallic components. However, a system that only includes the metal detector may only detect objects that include metal. Thus, the multi-sensor system may have better performance than a single-sensor system. Additionally, locating various complementary sensors in a single sensor head may further improve performance by reducing (perhaps eliminating) the need to register the data collected by the various sensors that view different aspects of the scene. Registration typically includes sampling a scene or region from different view points (such as sensors located in different positions relative to the region) and then transforming the collected data into a common coordinate system. Because multiple sensors are placed in the sensor head 110, the multiple sensors view the same portion, or nearly the same portion, of the region. As a result, the need to register the data from the various sensors included in the sensor head 110 may be reduced.

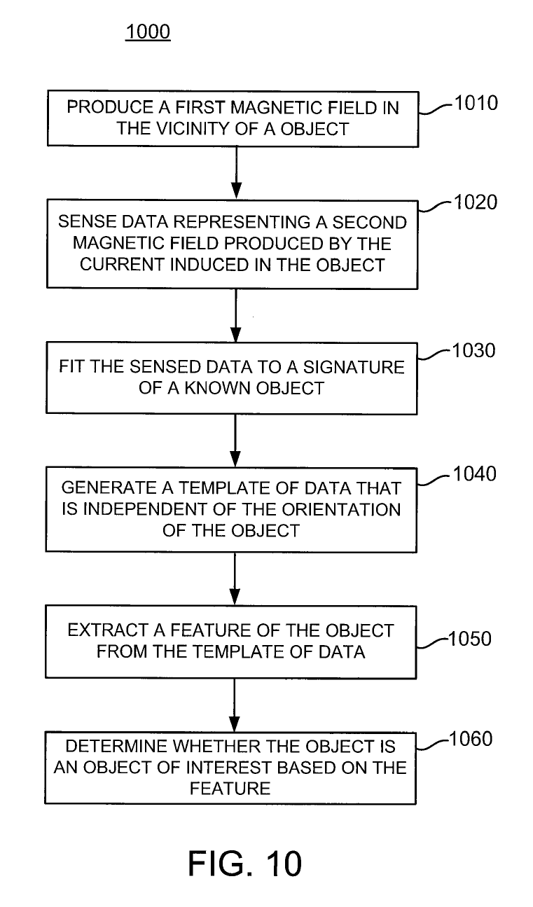

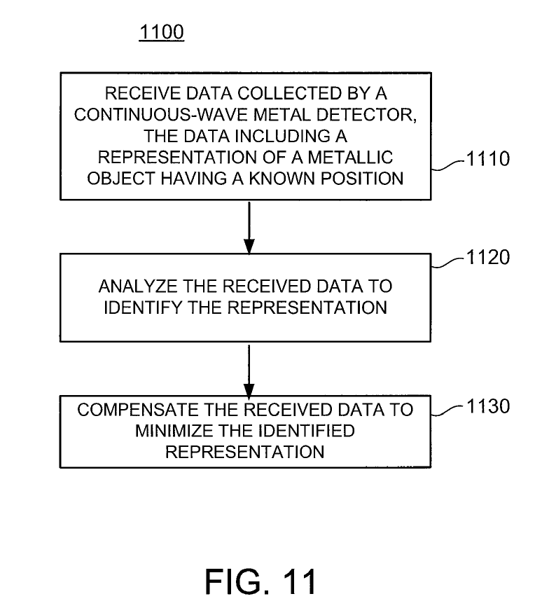

In some implementations, the sensor head 110 includes a continuous wave metal detector (CWMD) and a ground penetrating radar (GPR), such as CWMD 905 and GPR 940 of FIG. 9A. Some prior systems employed a GPR and a CWMD, but, in these systems, the GPR and the CWMD were separated by a distance sufficient to prevent the background or fixed metallic objects (such as metallic components of the GPR or the arm 120) from being detected by the CWMD. The separation distance in such systems may be one meter or more. Detection of background or fixed metallic objects by the CWMD creates noise in the CWMD data that results in the CWMD data being less than optimal. In contrast to these prior systems, the sensor head 110 includes a GPR and a CWMD in a single integrated sensor head, such as head 900 shown in FIGS. 9A and 9B. In the sensor head 110, the components of the GPR and the CWMD are positioned close enough to each other such that the CWMD senses the metallic components present in the GPR. However, the affects of placing the CWMD and the GPR in a single integrated sensor head are accounted for using signal processing techniques discussed below with respect to FIGS. 10 and 11. Additionally, the physical characteristics of the GPR and CWMD, discussed further with respect to FIGS. 12-16, also allow placement of both sensors in the sensor head 110.

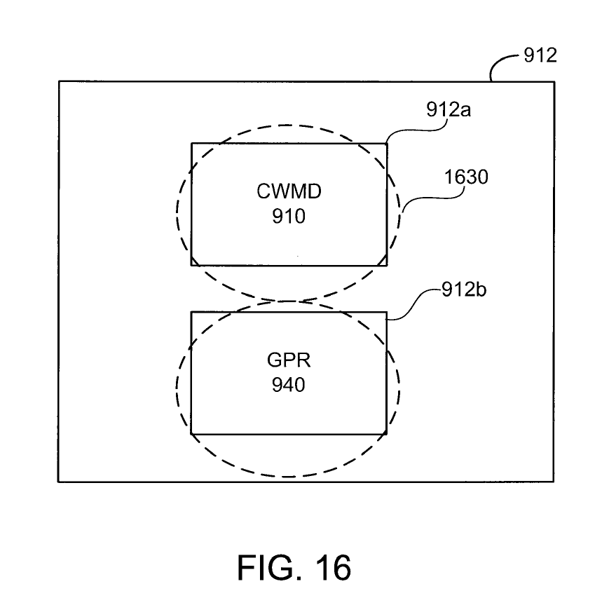

Referring to FIGS. 9A and 9B, an example of an integrated sensor head 900 that includes a ground penetrating radar (GPR) 940 and a continuous wave metal detector (CWMD) sensor 905 is shown. The integrated sensor head 900 may be used as the sensor head 110 discussed above. In the example shown in FIG. 9A, the sensor head 900 includes a CWMD 905 that has three channels, 910, 920, and 930, and a GPR 940. As discussed in greater detail with respect to FIGS. 16 and 16, the three channels of the CWMD correspond to three receive CMWD antennas. Each of the three CWMD receive antennas are formed by a metal coil being arranged about openings in a shell 912 that includes two openings for each CWMD antenna. In the example shown, the shell 912 includes six openings (three of which are hidden beneath the GPR 940).

The exterior of the example integrated sensor head 900 is shown in FIG. 9B. In some implementations, the sensor head 900 may be eight inches tall “T”, twelve inches deep “D”, and twenty-four inches wide “W.” In these implementations, the sensor head 900 may be mounted on a vehicle or cart. However, the sensor head 900 is scalable to a larger or smaller design. For example, a smaller sensor head 900 may be used in a handheld system. In implementations that involve a handheld system, the sensor head 900 may be, for example, eight inches wide and eight inches tall and may include a CWMD that has a single channel rather than three channels.

Referring to FIG. 10, a process 1000 for determining a signature of an object is shown. The process 1000 may be performed by a processor such as processor 132 included in the electronics module 130 discussed with respect to FIG. 1. The processor may be integrated with the sensor head 110 or the sensor head 110 may be separate from the processor. In examples in which the sensor head 110 is separate from the processor, the processor and the sensor head 110 may be in communication while the sensor head 110 is operating such that the processor receives data from the sensor head 110 and analyzes the data as the sensor operates. In the example discussed below and with respect to FIG. 10, the sensor head 110 includes a metal detector capable of sensing quadrature and in-phase data, such as a CWMD. However, in other examples, the sensor head 110 may include different or additional sensors.

A first magnetic field is produced in the vicinity of an object (1010). The object has an orientation relative to a direction of propagation of the first magnetic field and the first magnetic field induces a current in the object. In-phase and quadrature (“I&Q”) data representing the second magnetic field is sensed as a current arising in a coil of the sensor (1020). The sensed data is fit to a two-dimensional signature (1030). The two-dimensional signature may be a signature that represents the quadtrature data as a function of the in-phase data.

A template of data that is independent of the orientation of the object relative to the first magnetic field is generated (1040). The template of data also may be independent of an orientation of the object relative to a direction of propagation of radiation produced by the sensor and directed toward the target. The template of data may be a template that represents a three-dimensional object associated with a two-dimensional signature that matches, or closely matches, the two-dimensional signature found in (1030). The three-dimensional object may be found from among multiple candidate three-dimensional object by iterating through the potential three-dimensional space of I&Q data that could project into the two-dimensional signature found in (1030). The number of candidate objects may be reduced by removing non-logical values (non-positive values) until the iteration converges to a unique candidate three-dimensional model that projects the two-dimensional I&Q signature found in (1030) in real (positive) values.

In the model, the shape and material of each of the metallic objects is described using vectors representing amplitude and frequency, where frequency is the relaxation rate of the signature measured after being influenced by the electromagnetic field produced by the sensor. Because the three-dimensional model is a close approximation to the detected object, the orientation of the detected object relative to the sensor may be accounted for, and the vectors are independent of the relative orientation of the detected object and the sensor.

A feature of the object is extracted from the three-dimensional template (1050). The feature of the object is extracted from data that is derived from, or produced by, the three-dimensional template, such as the amplitude and frequency vectors discussed above.

Extracting a feature of the object may include determining an amplitude of the second magnetic field and determining a frequency of the second magnetic field or the relaxation rate of the detected object after being influenced by the electromagnetic field produced by the sensor. Extracting a feature of the object may include identifying, from the frequency vector, a first frequency value and a second frequency value. Extracting a feature of the object may include identifying, from the amplitude vector, a first amplitude value and a second amplitude value. In some examples, the feature may include a ratio of the first frequency value and the second frequency value and a ratio of the first amplitude value and the second amplitude value. Using the ratio instead of the raw frequency and amplitude values as the extracted feature values may remove noise from the value of the feature, particularly if the noise is common to all frequency values and/or all amplitude values. The first and second frequency values may be the two highest frequency values, and the first and second amplitude values may be the two highest amplitude values. The first and second amplitudes may be the amplitudes respectively associated with the first and second frequencies.

In some examples, a distance between the detected object and the sensor may be estimated. The estimated distance between the detected object and the sensor may be used to normalize the data collected by the sensor to a constant, arbitrary distance before extracting the feature values of the amplitude and frequency. Determining the distance between the detected object and the sensor allows the extraction and/or use of additional features. For example, the distance itself may be used as a feature.

Whether the object is an object of interest is determined based on the extracted features (1060). To determine whether the object is an object of interest, the extracted feature values may be input into one or more classifiers that are configured to produce a confidence value that may assume a range of numerical values, each of which indicates whether the object is more likely to be a target object or a clutter object. In some examples, the classifier is configured to produce a confidence value that is one of a discrete number of numerical values, each of which indicate whether the object is an object of interest (a target) or an object not of interest (clutter).

Although the example process 1000 includes determining the template of data that is independent of orientation (such as the three-dimensional object), this is not necessarily the case. In some implementations, data produced by the three-dimensional object is received by the processor from a pre-generated or separately generated template of data.

Techniques such as those discussed in FIG. 10 may be used to identify noise or artifacts in the CWMD data caused by the presence of nearby fixed or background metallic objects, such as the metal components of the GPR 940 in the sensor head 900. Identified noise or artifacts may be removed from the CWMD data. Removal of the noise or artifacts from the CWMD data allows the CWMD and the GPR to both be placed in the sensor head 900.

Referring to FIG. 11, an example process 1100 for operating a sensor head is shown. The process 1100 may be performed on one or more processors in communication with the sensor head 900. The processors may be part of the electronics module 130 discussed above with respect to FIG. 1. The process 1100 may be used to operate the sensor head 900 such that the GPR and CWMD collect data simultaneously, or nearly simultaneously, and the CWMD data is compensated for the presence of artifacts or noise due to detection of metallic components of the GPR, metallic components of the articulating arm 120 and/or metallic components of the platform 115.

Data collected by a continuous-wave metal detector (CWMD) is received (1110). The data includes a representation of a magnetic field produced by a current flowing in a metallic object that has a known position relative to the CWMD. The metallic object may be a metallic portion of a GPR (such as an antenna) that is in close proximity to the CWMD and included in the sensor head 900. The metallic object also may be an articulating arm that is in a fixed location relative to the CWMD. The object having a known position relative to the CWMD may be any piece of fixed metallic clutter that is part of a system that includes the CWMD or the object may be a portion of the environment in which the CWMD operates. For example, the object may be a portion of ground that includes metal. The received data is analyzed to identify the representation of the metallic object (1120). The received data is compensated to account for the representation of the metallic object (1130). Compensating for the representation of the metallic object may include removing the representation from the received data. In some implementations, compensating for the metallic object includes minimizing the representation.

The analysis techniques discussed with respect to FIGS. 10 and 11 may be used to identify, remove, minimize, and/or compensate for artifacts and noise caused stemming from placing the GPR and CWMD in the sensor head 900. Thus, the analysis techniques help make placement of the GPR and the CWMD in a single sensor head feasible. In addition to the analysis techniques discussed above, as discussed below, the design and physical parameters of the GPR and the CWMD also allow these sensors to be placed together in the sensor head 900.

In addition, as compared to CWMDs, in general, pulsed metal detectors transmit a pulse and detect an amplitude of a corresponding response signal, whereas a CWMD alternates between generating a fixed frequency signal and an amplitude signal. Changes in amplitude and phase of a corresponding received signal indicate the presence of a metallic object. Because the CWMD senses I&Q data, which includes amplitude and phase, rather than just the amplitude data that is detected by a pulsed metal detector, the effects of metallic clutter (such as soil and metal structural components of a detection system) are more apparent in data collected by the CWMD than in data from a pulsed metal detector. As discussed above, by identifying the metallic clutter as a non-target object, analysis such as that discussed with respect to FIGS. 10 and 11 allow the CWMD to be placed in the sensor head with the GPR.

Although some systems may have integrated a pulsed metal detector with a GPR, because of the nature of the data collected by a CWMD, the integration of a CWMD with a GPR is different from the integration of a pulsed metal detector and a GPR. Like data collected by a CWMD, data collected by a pulsed metal detector reflects the presence of metallic clutter. However, because data from a pulsed metal detector is amplitude-only, rather than I&Q, the effects of the metallic clutter appears relatively constant in the data collected by the pulsed metal detector. Thus, in systems employing a pulsed metal detector, the presence of metallic clutter may be removed (or otherwise compensated for) by performing an analysis that, for example, removes a constant level representing the metallic clutter from metal parts of the device from the signal.

However, removing a constant level from the I&Q data collected by a CWMD may introduce inaccuracy such that the CWMD data may be unusable to accurately discriminate between different types of objects.

The effects of the metallic clutter on the I&Q data collected by a CWMD may vary based on metallic clutter in the sample being searched. For example, the metallic clutter may be a metallic soil in which an underground pipe (the target) is buried. The amount and distribution of the metal in the soil may vary slightly over a region scanned by the CWMD. The I&Q data from the CWMD reflects the variation more than amplitude data collected from a pulsed metal detector scanned over the same region. Thus, use of an analysis such as that discussed with respect to FIGS. 10 and 11 may be helpful in removing the effects of the metallic soil from the CWMD data.

Additionally, the techniques discussed with respect to FIG. 10 allow removal of the effect of fixed, or semi-fixed, metal objects in the vicinity of the CWMD, such as a metallic robotic arm, a metallic platform on which the sensor head 900 is mounted, or metal components of a GPR antenna located near the CWMD receive antenna. These items may be sensed by the CWMD, and removal of the effects of the sensing of these items may allow the CWMD and the GPR to be placed together in the sensor head 900.

Referring to FIG. 12, a block diagram of the sensor head 900 is shown. The sensor head 900 includes a GPR transceiver 940 and a CWMD 905.

The CWMD 905 produces a magnetic field sufficient to induce a current in a metallic object in the vicinity of the CWMD 905. The induced current flows in the metallic object and creates a second magnetic field. The parameters of the second magnetic field depend on characteristics of the object such as the amount of metal in the object. The CWMD 905 senses the second magnetic field and generates a representation of the metallic object based on the sensed second magnetic field. The CWMD 905 may transmit a magnetic field signal that has twenty-one frequencies that are logarithmically spaced and within a frequency band of about 330 Hz to 90 kHz.

The GPR transceiver 940 transmits and receives radio-wave (or microwave) signals. The GPR 940 may operate in a frequency range of 700 MHz to 4 GHz. Operation in this frequency band allows for potentially greater depth penetration and improved imaging performance for applications in which the sensor head 900 is used to image a region beneath the surface of the ground. The GPR 940 may be a continuous-wave radar that transmits radio-wave signals having linear polarization.

In some implementations, the sensor head 900 also includes a single-board computer (SBC) 960. The SBC 960 may include the electronic components of the electronics module 130, electronics for interfacing with the GPR 940 and the CWMD 905, and electronic storage for storing instructions to cause a processor to perform data processing such as discussed in FIGS. 10 and 11. In implementations of the sensor head 900 that include the SBC 960, the GPR 940 and the CWMD 905 each exchange data with the SBC 960, and the SBC 960 exchanges data with a computer 970 external to the sensor head 900. The computer 970 may include all or some of the electronics in the electronics module 130. In implementations that do not include the SBC 960, the GPR 940 and the CWMD exchange data with the computer 970.

The sensor head 900 also may communicate with an inertial measurement unit (IMU) 975 that tracks the position of the sensor head 900. In the example shown, the IMU 975 receives position measurements from the GPR 940. In other implementations, the IMU 975 may receive position measurements from the CWMD 910, the computer 970, and/or the SBC 960.

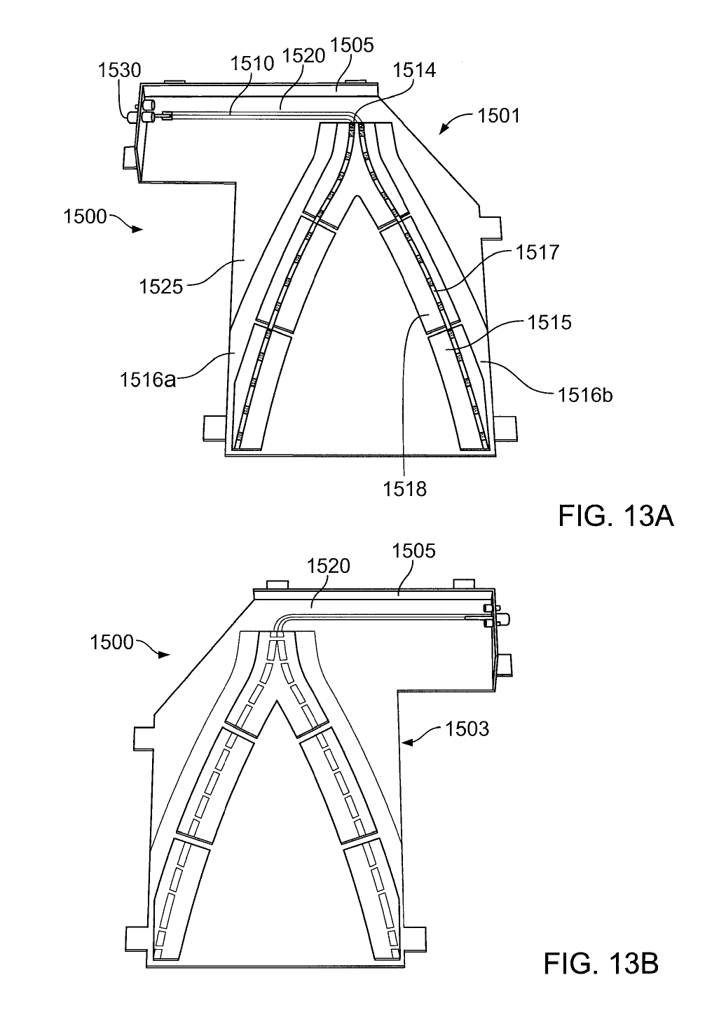

Referring to FIGS. 13A and 13B, a cross-section of an antenna used in the GPR 940 is shown. The portions shown in each of FIGS. 13A and 13B butt together along a top ridge 1505 to form an antenna 1500 that is sized to be placed in the sensor head 900. The portion of the antenna 1500 shown in FIG. 13A is a first antenna half 1501, and the portion of the antenna 1500 shown in FIG. 13B is a second antenna half 1503.

The antenna 1500 shown in FIGS. 13A and 13B has a folded-over feed line 1510 that forms a right-angle, or nearly a right-angle 1514, with a resistive vee (“v”) element 1515. The feed line 1510 carries microwave signals to and from the resistive element 1515, and the feed line 1510 is coupled to the resistive element 1515 at the angle 1514. Some prior systems had a feed line that was co-planar with a resistive element and extended straight out from the top of the resistive element rather than being curved to form an angle with the resistive element. The folded-over feed line 1510 may result in the antenna 1500 being more compact than antennae used in other GPR systems. The compacted antenna 1500 is small enough to be stacked with other antennas and fit into the sensor head 900. The relatively small size of the antenna 1500 also may help to minimize the weight of the sensor head 900 such that the sensor head 900 is mountable on a relatively small and lightweight robotic platform (not shown).

To achieve the folded over feed design, a radar-absorbing material (RAM), such as C-RAM MT available from Cumming Microwave of Avon, Mass., is placed around the feed-line 1510. The presence of the radar-absorbing material 1520 allows the feed-line 1510 to operated in the folded over position by eliminating or minimizing the effects of currents flowing in the feed line 1510 on the operation of the resistive element 1515. In some implementations, the feed-line 1510 is placed adjacent to a hollow 1520 that is formed between the top ridges 1505 on the first and second antenna halves 1501, 1503 when the halves are butted together. The hollow 1520 is padded, filled, or otherwise includes the radar-absorbing material.

Referring to FIG. 13A, the resistive element 1515 includes two curved arms 1516a and 1516b. The curved arms 1516a and 1516b are printed on a film such as Kapton® film available from the Dupont Corporation. The curved shape of the arms 1516a and 1516b helps to minimize reflections between the resistive element 1515 and the feed line 1510. For example, the curved shape may help input pulses from the feed line 1510 to be continuously reflected from the arms 1516a and 1516b whereas a design with straight arms may reflect most of the input pulse at the drive point where the feed line meets the resistive element. Individual resistive elements 1517 are placed along the curved arms 1516a and 1516b such that the resistive element 1515 approximates a continuous resistive profile. The resistive elements 1517 may be surface mount resistors. Additionally, to approximate a continuous loading profile having discrete resistors, each arm 1516a and 1516b may be divided into multiple sections 1518. The sections 1518 are chosen such that the resistance of each section 1518 agrees with a pre-defined resistive profile.

The pre-determined resistive profile may be derived from or otherwise based upon, for example, the Wu-King (WK) resistive profile.

To improve the mechanical reliability of the antenna 1500, the resistive element 1515 may be sandwiched between two blocks of a non-conductive material, such as polystyrene foam, and/or the resistive element 1515 may be attached to a dielectric substrate 1525. The foam may be encased in a heat-sealable plastic. Other components of the antenna 1500, such as the feed-line 1510, may be placed between the non-conductive material and/or attached to the substrate. In implementations in which the resistive element 1515 is attached to the substrate 1525, the material of the substrate 1525 has a relative permittivity, or dielectric constant, (∈_{R}) close to 1 to minimize performance degradation caused by the presence of the substrate 1525, the substrate 1525 is relatively thin, and the arms 1516a and 1516b are relatively wide. To further minimize the effects of the substrate 1525, the substrate may be cut out around the resistive element 1515.

The feed line 1510 is coupled to a connector 1530 that allows the signals from the resistive element 1515 and carried by the feed line 1510 to be coupled out of the antenna 1500 for further analysis or coupled into the antenna 1500 to, for example, excite a region with a particular signal.

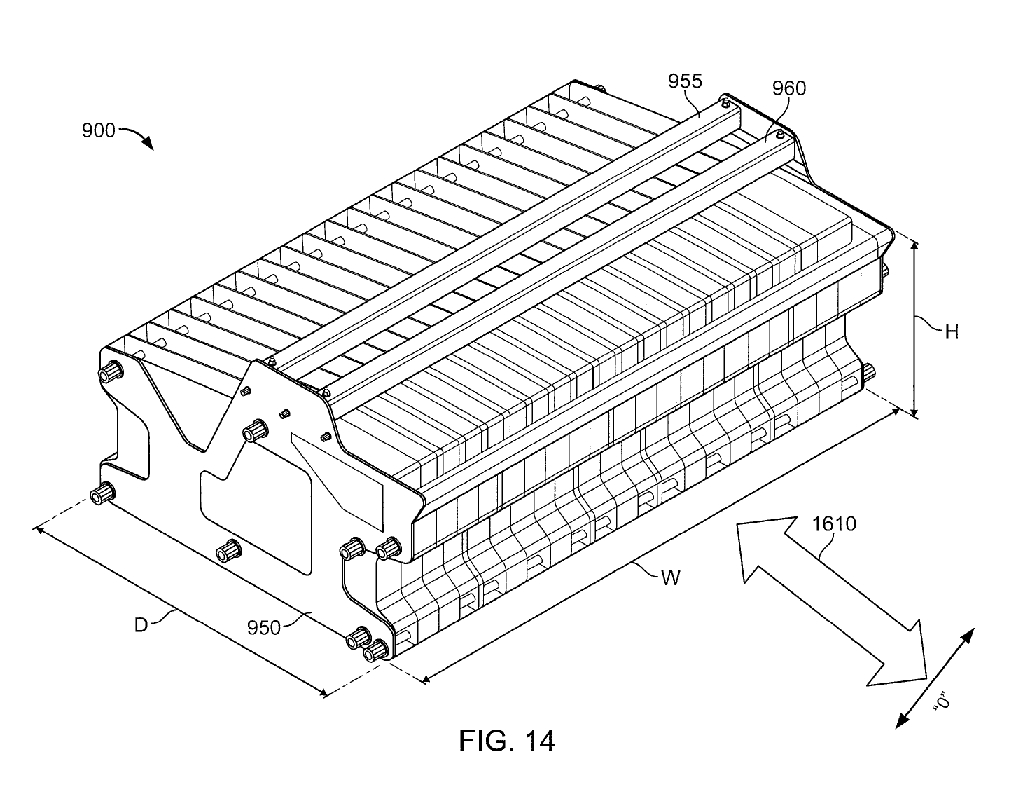

Referring to FIG. 14, a perspective view of the sensor head 900 is shown. The sensor head 900 is configured such that a bottom 950 is placed parallel, or approximately parallel, to a surface to be imaged or otherwise examined with the sensor head 900.

The sensor head 900 includes a rigid exterior. The rigid exterior may be formed from a rigid portion of the antenna 1500. The rigid exterior of the sensor head 900 may include a rigid Styrofoam. The rigid Styrofoam protects the GPR and CWMD sensors while also keeping the weight of the sensor head 900 relatively low. In other examples, the sensor head 900 is placed within a housing that holds the CWMD and the GPR. The housing may be a plastic housing.

The sensor head 900 includes a GPR and a CWMD. In this example, the sensor head 900 includes eighteen v-dipole GPR antennas, three CWMD receive antennas, and one CWMD transmit antenna. The transmit and receive CWMD antennas may be formed as a coil that is sufficiently thin to fit between two GPR antennas. As discussed above, a CWMD transmit antenna emits a magnetic field having sufficient strength to induce current in metallic portions of items in the vicinity of the transmit antenna. The induced current generates a second magnetic field, and the CWMD receive antenna detects that second magnetic field and produces a representation of the strength of the magnetic field. Upon further processing, the representation may be used to identify and/or categorize the object.

In the example of FIG. 14, each of the eighteen v-dipole antennas includes the antenna 1500 discussed with respect to FIGS. 13A and 13B. The design of the antenna 1500 allows the GPR antennas to be stacked and placed in the sensor head 900. The eighteen GPR antennas are grouped into three sets of six antenna and placed with one of the three CWMD receive antennas. The three sets of six antenna are stacked along the width (“W” direction) of the sensor head 900. In some implementations, a single CWMD receive antenna is interleaved with the six GPR antennas. In some implementations, the CWMD receive antenna is placed between two adjacent GPR antennas. The CWMD receive antenna and/or the CWMD transmit antenna may be separated by about 1-centimeter. The CWMD transmit antenna may be located in the sensor head 900 such that the transmit antenna emits a magnetic field from a bottom 950 of the sensor head 900.

In operation, the sensor head 900 is swept along a direction 1610 and collects data while scanning. When operated in the direction 1610, the sensor head 900 collects data that may be analyzed or otherwise manipulated to produce an image of the region directly below the sensor head 900. For example, the sensor head 900 may be placed over the ground, and the image produced by the data from the sensor head 900 may include features of the region that are beneath the surface of the ground. The sensor head 900 also may be moved in a direction other than the direction 1610. For example, the sensor head 900 may be moved approximately parallel to the surface of the ground in a direction “O” that is orthogonal to the direction 1610. Because of the arrangement of the GPR antennas along the “W” direction, scanning the sensor head 900 in the direction “O” results in multiple GPR and CWMD antennas examining the same portion of ground, thus resulting in the collection of redundant data. The redundant data may be used in applications that benefit from multiple looks at the same region.

The sensor head 900 also includes supports 955 and 960. The supports 955 and 960 help to support the sensor head 900 and hold the sensor head 900 together. The supports 955 and 960 also may be used to attach the sensor head 900 to the plate 410 and/or to the arm 120. The supports 955 and 960 are coupled to the sensor head 900 with bolts or other fasteners. The sensor head 900 also includes other supports that are internal to the rigid exterior of the sensor head 900.

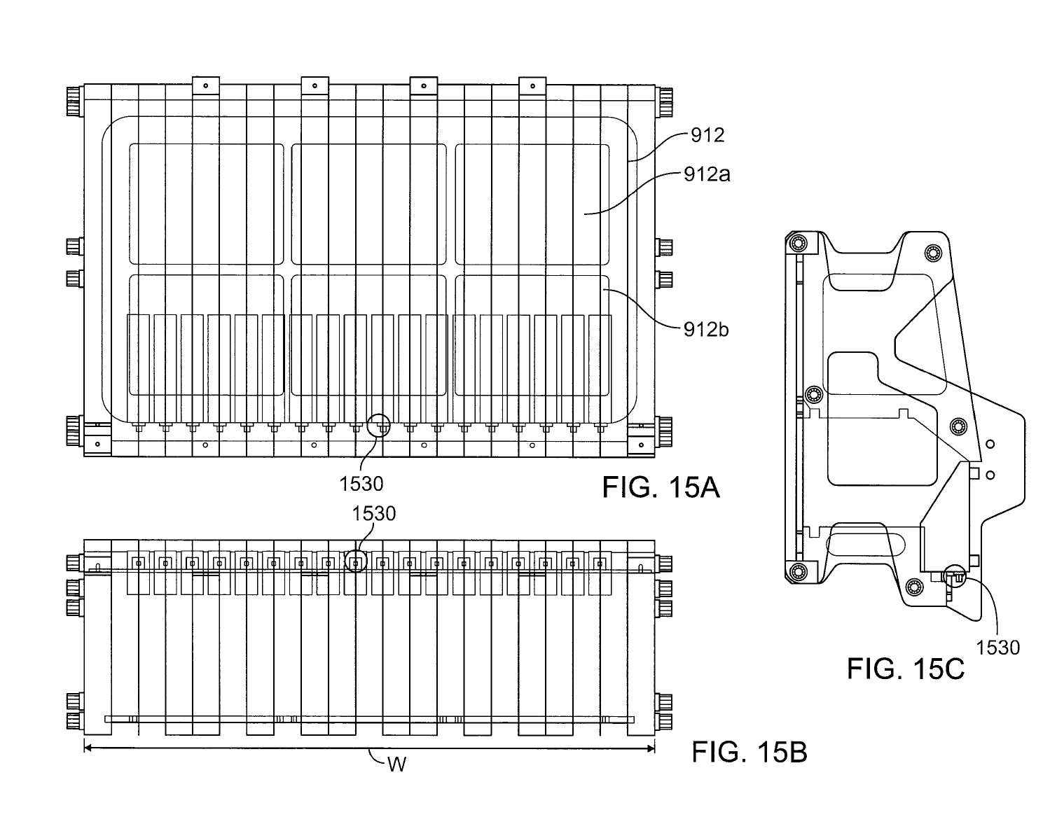

Referring to FIG. 15A-15C, three views of the sensor head 1500 are shown. FIG. 15A is a plan view of the sensor head 900 as viewed from the bottom 950. FIG. 15B shows the sensor head 900 from the front along the “W” direction. FIG. 15C shows the sensor head 900 from the side. Referring to FIG. 15A, the connectors 1530 of each of the eighteen GPR antennas are arranged along the “W” direction of the sensor head 900. FIGS. 15A and 15B show the stacked arrangement of the eighteen GPR antennas 940. Referring again to FIG. 15A, each of the three transmit CWMD antennas are arranged about the openings of the shell 912. For example, a single CWMD antenna (not shown) may be formed by arranging a thin, flexible metallic coil about the openings 912a and 912b such that the metallic coil is interleaved or otherwise in close proximity to the six GPR antenna 940 placed near the shell 912. Referring to FIG. 16, a schematic of the placement of a CWMD antenna coil 1630 and a GPR antenna 940 in the shell 912 is shown. Thus, in the sensor head 900, the size and shape and isolation of the GPR antennas 1500 allow the GPR antenna 1500 to be stacked closely together and placed in the sensor head 1500.

Other implementations are within the scope of the claims. For example, the GPR 940 may operate up to 8 GHz.

What is claimed is:

1. An antenna comprising:
a resistive element formed in a casing; and
a feed line formed in the casing and electrically coupled to the resistive element, the positioning of the resistive element and the feeding being such that the feed line is approximately perpendicular to the resistive element.

2. The antenna of claim 1, wherein the resistive element is a resistive vee.

3. The antenna of claim 1, wherein the positioning of the feed line and the resistive element results in the antenna being sized to allow integration of the antenna into a sensor head.

4. The antenna of claim 1, further comprising radar-absorbing material surrounding the feed line.
